(19) United States
(12) Patent Application Publication
(10) Pub. No.: US 2007/0216666 A1
(43) Pub. Date: Sep. 20, 2007

(54) TELEVISION DISPLAY SYSTEM FOR PORTABLE COMMUNICATION DEVICE

(76) Inventor: Khaled Anis, Oldsmar, FL (US)

Correspondence Address: WOOD, HERRON & EVANS, LLP, 2700 CAREW TOWER, 441 VINE STREET, CINCINNATI, OH, 45202, US

(21) Appl. No.: 11/276,868

(22) Filed: Mar. 17, 2006

(51) Int. Cl. G09G 5/00

(52) U.S. Cl. 345/204

(57) ABSTRACT

A display device receives and initiates the display of television broadcast signals on the display of a portable communication device. The display device automatically scans for the strongest UHF/VHF signal available through an antennae. The strongest channel(s) may be displayed in a LCD panel along with its associated signal strength, UHF/VHF band, volume level and other pertinent information. A wireless or cable interface of the display device may be in electronic communication with a cellular phone, personal digital assistant or personal computer configured to view a television program conveyed in the broadcast signals.

### CROSS REFERENCE TO RELATED APPLICATIONS

This application claims benefit of priority to U.S. patent application Ser. No. 11/368,849, entitled “TELEVISION DISPLAY SYSTEM FOR PORTABLE COMMUNICATION DEVICE” filed on Mar. 6, 2006 by Khaled Anis, which claims priority to Provisional Patent Application No. 60/658,692, entitled “LCD ATTACHMENT FOR RECEIVING RADIO WAVES” filed Mar. 4, 2005 by Khaled Anis, both of which are incorporated herein by reference in their entirety.

### FIELD OF THE INVENTION

The present invention generally relates to portable communication devices, and more particularly, to portable communication devices having video compatible displays.

### BACKGROUND OF THE INVENTION

The practicality and convenience of cellular phones, personal digital assistants (PDA's), laptop computers and other portable communication devices has made them indispensable to many. Once largely viewed primarily as business tools, portable communication devices have culturally and functionally evolved as key personal and social tools. Networked, portable communication devices are routinely used to send electronic text messages, take pictures, browse the Internet, as well as to download digitized streams, or packets, of music and video.

To this end, portable communication devices typically include displays for the presentation of information to users. For instance, portable communication devices routinely include liquid crystal display (LCD) technologies configured to display text, as well as pixelized photographic and video data. In the case of video data, motion picture clips of digitized, streaming video data is be sent to a portable communication device in the form of a data packet. The portable communication device may then cache the data packet until a user is ready to open the packet. Alternatively, a user may connect to an Internet link having the video data for downloading to the portable communication device in accordance with MP3 or another applicable data packet format.

Despite advances in this field, many portable communication devices are not equipt with adequate memory or processing power to accommodate extremely large video data packets. This limitation reduces the type and duration of material that may be viewed on the display of a portable communication device. Additionally, the content of the downloaded video packets may also be somewhat limited by virtue of having to be pre-recorded and formatted for packet processing and distribution. Certain media content, e.g., television programs, may not be readily available in this format.

There consequently exists a need for an improved manner of integrating media functionality into portable communication devices.

### SUMMARY OF THE INVENTION

The present invention provides an improved and method for presenting television data on a display of a portable communication device. In one embodiment, a receiver may receive a broadcast television signal. The television signal typically comprises a very high or ultra high frequency signal broadcast form a station. A controller may use the received television signal to initiate the display of a television program on a display of the portable communication device. As such, the display of the portable communication device may be configured to present video data of the television program.

The controller may be in electronic communication with the portable communication device. For instance, the controller housed within a display device may be cabled to the portable communication device. Alternatively, the controller may be in wireless communication with the portable communication device. In one embodiment, at least one of the receiver and the controller may be housed integrally within the portable communication device.

The controller may scan the television signal(s) to determine a number of channels suitable for presentation. The controller may initiate any necessary formatting prior to communicating the television signal, including video and/or audio components, to the portable communication device(s). Exemplary portable communication devices may include cellular phones, personal digital assistants and laptop computers. Where desired, the receiver and/or controller may be selectively and/or remotely activated and deactivated.

As such, embodiments of the present invention capitalize on underutilized functionality of portable communication devices and on the availability of broadcast television signals to present television programs to a user at any location where they travel with their portable communication device.

These and other advantages and features that characterize the invention are set forth in the claims annexed hereto and forming a further part hereof. However, for a better understanding of the invention, and of the advantages and objectives attained through its use, reference should be made to the Drawings, and to the accompanying descriptive matter, in which there is described exemplary embodiments of the invention.

### BRIEF DESCRIPTION OF THE DRAWINGS

FIG. 1 is a block diagram of a display system in accordance with the principles of the present invention.

FIG. 2 shows a display device configured to receive and initiate the display of a television broadcast signal on the display of a portable communication device.

FIG. 3 is a flowchart having process steps executable by the display device of FIG. 2.

### DETAILED DESCRIPTION

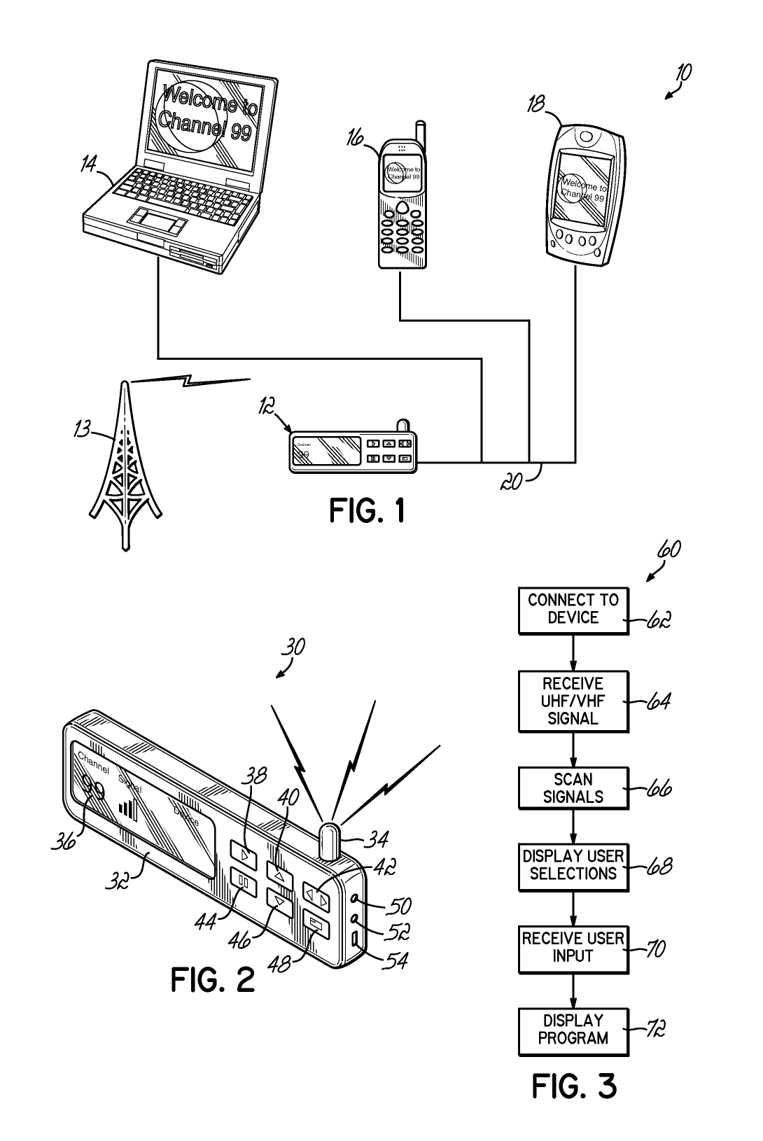

An embodiment consistent with the invention receives and initiates the display of television broadcast signals on the display of a portable communication device. To view realtime television on a portable communication device, the embodiment shown in FIG. 1 relies on a display device 12 configured to receive a broadcast television signal. The display device 12 uses the received television signal to initiate its presentation on the display of a portable communication device 14, 16 and/or 18.

The display device 12 may automatically scan for the strongest UHF/VHF signal broadcast from an antenna 13. The strongest channel(s) of the television signals may be displayed in a liquid crystal display (LCD) panel of the display device 12, along with its associated signal strength, UHF/VHF band, volume level and/or other pertinent information. A wireless or cable interface of the display device 12 may be in electronic communication with a personal computer 14, cellular phone 16 and/or PDA 18 having a display configured to view a television program conveyed in the broadcast signals.

Generally regarding FIG. 1, the display device 12 receives a television broadcast signal from a broadcast antenna 13. The broadcast television signal may comprise radio frequency signals, e.g., UHF or VHF signals, such that are typically broadcast over the air by a local television station. The display device 12 receives and optionally formats (if necessary) the broadcast signal. The display device 12 may then relay the television signal to a display of a portable communication device 14, 16, 18 in electronic communication with the display device 12. This electronic communication may be accomplished via a cable or a wireless connection. Moreover, while the display device 12 shown in FIG. 1 is a separate device from the laptop computer 14, cellular telephone 16 and PDA 18, one skilled in the art will appreciate that another embodiment of the display device 12 may include receiver and controller circuitry integrated into the housing of a portable communication device.

FIG. 2 shows a display device 30 configured to receive and initiate the display of a television broadcast signal on the display of a portable communication device. The display device 30 includes a housing 32 that may partially enclose an antenna 34 and control circuitry (not shown). The antenna 34 may be telescoping or foldable where desired, and may comprise an analog and/or digital receiver antenna. The antenna of another embodiment may comprise a transceiver configured to wirelessly send signals to portable communication devices.

The display device 30 includes a display 36 configured to display signal strength, channel, volume and other information. A typical display 36 may comprise an LCD. User interface controls 38, 40, 42, 44, 46 and 48 may include a manual/automatic scan up and down buttons, volume buttons, a mute button, and/or an on/off button for user manipulation.

The dimensions of the housing 32 may vary widely per application specifications, but as shown in FIG. 2 approximate two and one-half inches in length, one inch in width and one-half inch in depth. Ports 50, 52 and 54 may provide for audio and video output interfaces, as well as a power input interface. The display device 30 may be battery powered, and/or may include input ports for AC or DC power. Where desired, the display device 30 may additionally include a port to receive headphones.

The flowchart 60 of FIG. 3 illustrates exemplary methods steps that are consistent with the principles of the present invention. The method steps of the flowchart 60 are executable by the display device 12 of FIG. 1 generally for receiving and initiating the display of television broadcast signals on the display of a portable communication device 14, 16, 18. At block 62 of FIG. 3, the display device 12 may connect to or otherwise be in electrical communication with one or more portable communication devices 14, 16, 18. The antenna 34 or other receiver of the display device 12 may receive a broadcast television signal(s) at block 64.

A controller of the display device 12 may initiate scanning at block 66 for the strongest channels of the television signal(s). Information indicative of signal strength may be displayed at block 68 to the user. Where necessary, the controller may initiate any necessary signal conversions, e.g., analog-to-digital.

At block 70, the user may input channel and volume selections. At block 72, the display device 12 may initiate the display of a television program on a display of the portable communication device 14, 16, 18. That is, the audio and video portions of a television program may be viewed via the portable communication device 14, 16, 18.

While the present invention has been illustrated by a description of various embodiments and while these embodiments have been described in considerable detail, it is not the intention of the applicants to restrict, or in any way limit, the scope of the appended claims to such detail. For instance, while embodiments described above focus on video data, other display devices consistent with the present invention may allow strictly audio, radio program broadcast signals to be played in realtime by the portable communication devices. Additionally, embodiments of the present invention may receive video data from satellite.

As such, additional advantages and modifications will readily appear to those skilled in the art. The invention in its broader aspects is therefore not limited to the specific details, representative apparatus and method, and illustrative example shown and described. For instance, a controller of a display device may be selectively activated. In a commercial context, a user may subscribe to a service that activates the receiver and/or controller of the display device so that the device only initiates the display of television data when a user has subscribed. To this end, activation of the controller and/or receiver may be monitored and recorded, e.g., for billing purposes. Accordingly, departures may be made from such details without departing from the spirit or scope of applicant's general inventive concept.

What is claimed is:

1. An apparatus comprising:
a portable communication device comprising a display;
a receiver configured to receive a broadcast television signal comprising video data; and
a controller in electronic communication with the receiver and the portable communication device, wherein the controller is configured to cause the display to display the video data.

2. The apparatus of claim 1, wherein at least one of the receiver and the controller are integrated within a housing of the portable communication device.

3. The apparatus of claim 1, wherein the controller is in wirelessly connected to the portable communication device.

4. The apparatus of claim 1, wherein the controller is cabled to the portable communication device.

5. The apparatus of claim 1, wherein the controller is further configured to scan a plurality of signals conveyed in the television signal.

6. The apparatus of claim 1, wherein the controller is further configured to format the television signal.

7. The apparatus of claim 6, wherein the controller is further configured to format the television signal using at least one of an analog-to-digital converter and a digital-to-analog converter.

8. The apparatus of claim 1, wherein the portable communication device is selected from a group consisting of at least one of a laptop computer, a cellular phone and a personal digital assistant.

9. The apparatus of claim 1, wherein use of at least one of the controller and the receiver is selectively activated.

10. The apparatus of claim 1, wherein a user is billed for use of at least one of the controller and the receiver.

11. The apparatus of claim 1, wherein use of at least one of the controller and the receiver is recorded.

12. The apparatus of claim 1, wherein the television signal comprises at least one of an ultra high frequency and a very high frequency signal.

13. An apparatus comprising:
a television broadcast antenna configured to broadcast a television signal comprising video data;
a portable communication device comprising a display configured to display the video data;
a receiver configured to receive the television signal; and
a controller in electronic communication with the receiver and the portable communication device, wherein the controller is configured to cause the display to display the video data.

14. A method of presenting television data on a display of a portable communication device, the method comprising:
receiving a television signal comprising video data broadcast from a television broadcast antenna; and
displaying the video data on the display of the portable communication device.

15. The method of claim 14, further comprising receiving the television signal at a receiver.

16. The method of claim 14, further comprising communicating the received television signal to the display of the portable communication device.

17. The method of claim 14, wherein receiving the television signal further comprises receiving a radio frequency signal.

18. The method of claim 14, wherein receiving the television signal further comprises receiving at least one of an ultra high frequency and a very high frequency signal.

19. The method of claim 14, further comprising formatting the television signal to be compatible with the display of the portable communication device.

20. The method of claim 14, further comprising determining a strongest channel.
